(19) United States
(12) Patent Application Publication
(10) Pub. No.: US 2008/0159112 A1
(43) Pub. Date: Jul. 3, 2008

(54) Spot Size Focus Error Detection For Multiple Beam Optical Scanning Device

(75) Inventors: Alexander Marc Van Der Lee, Eindhoven (NL); Coen Theodorus Hubertus Fransiscus Liedenbaum, Eindhoven (NL); Teunis Willem Tukker, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/815,107

(22) PCT Filed: Jan. 26, 2006
(86) PCT No.: PCT/IB2006/050284

§ 371 Date: Jul. 31, 2007

(30) Foreign Application Priority Data
Feb. 3, 2005 (EP) 05100734.2

(51) Int. Cl. G11B 7/00

(52) U.S. Cl. 369/112.01

(57) ABSTRACT

A device (1) for scanning an optical disc (6), the disc (6) comprising substantially parallel data tracks (10). The device (1) comprises an optical unit for creating track light spots (12) on the data tracks (10) and a plurality of detector light spots on a plurality of signal detectors. The device further comprises a focus error unit for with a beam manipulating element (21, 22, 22a, 92) for providing for at least one of the reflected beams a first optical path (24) to a first segmented detector (8a) and a second optical path (25) to a second segmented detector (8b). The lengths of the first optical path (24) and the second optical path (25) exhibit a difference (Dd), such that an intensity distribution of a first detector light spot on the first segmented detector (8a) is equal to an intensity distribution of a second detector light spot on the second segmented detector (8b) when the at least one track light spot is correctly focussed and that the intensity distribution on the first segmented detector (8a) differs from the intensity distribution on the second segmented detector (8b) when the at least one track light spot is not correctly focussed. The difference (Dd) is substantially less than a quotient of a distance between two adjacent detector light spots (Ds) and a numerical aperture (NA) of the lens (7). A dimension (D1) of a light detecting area of the segmented detectors in a direction of adjacent detector light spots is less than the distance (Ds) between two adjacent detector light spots.

The invention relates to a device for scanning an optical disc, the disc comprising substantially parallel data tracks, the device comprising an optical unit for creating a plurality of track light spots on the data tracks, the optical unit comprising a lens for creating, from a plurality of light beams reflected at the data tracks, a plurality of detector light spots on a plurality of signal detectors, and a focus error unit for providing a focus error signal, indicating an amount of defocus of at least one track light spot of the plurality of track light spots.

Such a device is known from the international patent application WO 02/071400. This application discloses an apparatus using multiple reading beams and a multi-element detector for simultaneously reading data from multiple data tracks on a CD or DVD disc. A holographic element introduces astigmatism into the central beam. A central segmented detector, comprising a 2 by 2 array of detector segments, is used for astigmatic focus error detection. If the system is in focus, the spot projected on the central detector will be round, illuminating all detector segments equally. If the system is out of focus, the spot will be elongated diagonally, so that one diagonal pair of segments receives greater illumination than another diagonal pair, depending on the direction of the focus error. In the apparatus disclosed by WO 02/071400, the central segmented detector is also used for push pull tracking error detection.

It is an object of the invention to provide a device for scanning optical discs, using a different, more reliable technique for determining a focus error.

According to the invention a device as described in the opening paragraph is provided, wherein the focus error unit comprises a beam manipulating element for providing for at least one of the reflected beams a first optical path to a first segmented detector and a second optical path to a second segmented detector, the lengths of the first optical path and the second optical path exhibiting a difference, such that an intensity distribution of a first detector light spot on the first segmented detector is substantially equal to an intensity distribution of a second detector light spot on the second segmented detector when the at least one track light spot is correctly focussed and that the intensity distribution on the first segmented detector differs from the intensity distribution on the second segmented detector when the at least one track light spot is not correctly focussed. The focus error unit further comprises comparing means for comparing the intensity distribution on the first segmented detector to the intensity distribution on the second segmented detector for determining the focus error signal. The difference between the path lengths is substantially less than a quotient of a distance between two adjacent detector light spots and a numerical aperture of the lens, and a dimension of a light detecting area of the segmented detectors in a direction of adjacent detector light spots is less than the distance between two adjacent detector light spots.

The multiple beams scanning device according to the invention uses spot size detection for determining a focus error. Spot size focus error detection is a previously used technique for determining a focus error in single beam scanning devices. When a track light spot is correctly focused on a track of the optical disc, the light beam reflected at the track is converged by the lens and split by the beam manipulator, such that a first optical path reaches the first segmented detector before a focus point of a detector light spot and the second optical path reaches the second segmented detector after a focus point of a detector light spot. If the distances from the first and the second segmented detector to the focus point are equal, the intensity distributions on the first and on the second segmented detectors are identical. When the track light spot is not correctly focused on the optical disc, the focus point of the detector light spot is shifted towards the first segmented detector and away from the second segmented detector, or vice versa. One of the segmented detectors then becomes closer to the focus point than the other one, resulting in different intensity distributions for the first and the second segmented detector. By comparing the intensity distributions of both segmented detectors, the amount of defocus can be determined.

In single beam scanning devices the difference between the lengths of the first and second optical path and the surface area of the segmented detectors are preferably large enough for enabling reliable focus error detection over the whole range of focus errors which may occur during normal use of the device. This means that the difference between the lengths of the first and second optical path should at least equal the width of the range of possible focus errors and that the surface area of the segmented detectors should at least be as large as a light spot at the outer edge of said range. The invention is based on the recognition that in multiple beams scanning devices, overlapping beams negatively influence the quality of spot-size focus error detection. Close to the focus point of the second spot the beams are well separated, but out of focus the beams very quickly overlap. Cross talk from adjacent overlapping beams will severely hamper the generation of a reliable focus error signal. Hence, up to now, spot size focus error detection has not been considered for multiple beams scanning devices. The inventors have seen that by decreasing the difference in length for the first and second optical path and the size of the segmented detectors, the cross talk of overlapping beams can be minimized. If the difference in length of the optical paths is too large, at least one of the segmented detectors is at a position where adjacent light beams overlap, regardless the focus error. If the segmented detectors are too big light from multiple beams will simultaneously fall on one segmented detector, even if the segmented detector is exactly in focus. As long as the segmented detectors operate in an area where beams of adjacent spots are well separated, spot size focus error detection can be applied to scanning devices using multiple beams for simultaneous reading of multiple data tracks. This area is defined by two limits. First, the difference between the path lengths is substantially less than a quotient of a distance between two adjacent detector light spots and a numerical aperture of the lens. Second, a dimension of a light detecting area of the segmented detectors in a direction of adjacent detector light spots is less than the distance between two adjacent detector light spots. A detailed description of the origin and the calculation of the dimensional limits is provided later on, with reference to FIG. 5.

When using astigmatic focussing with multiple beams scanning devices the use of an aberated (astigmatic) lens results in larger spots than when using a none aberated lens. Larger spots will already overlap at lower values of defocus. It is an advantage of the device according to the invention that no aberated lenses are used.

In an embodiment of the device according to the invention the focus error unit comprises adding means for adding intensities detected by segments of the first segmented detector and the second segmented detector for providing an approximate focus error signal. Due to the small optical distance and the small size of the two segmented detectors in the device according to the invention, the comparison of the intensity distributions can only reliably be used for the detection of relatively small focus errors. The total intensity on both segmented detectors is a reliable measure for larger, approximated focus errors. The total intensity peaks when the spot is near the correct focus point. When the spot is near the correct focus point, the comparing means are used for a more precise determination of the focus error based on the spot size detection.

In another embodiment according to the invention the beam manipulating element is a glass plate comprising a holographic part for splitting the at least one of the reflected beams for providing the first optical path and the second optical path. The glass plate may, for example, be a holographic glass plate centred only above the segmented detectors for only splitting the at least one beam. Alternatively a larger glass plate may be used which comprises a holographic part for splitting the at least one beam and is transmissive for the other beams. The glass plate ensures that only the relevant light spot (at least in the focus region, where the light beams are separated) is used for the spot size detection, the other light beams are directly focussed onto their single signal detectors.

In another embodiment of the device according to the invention, the focus error unit is arranged for providing at least two focus error signals, for at least two track light spots and for deriving an angular error signal there from. When focus errors differ for different light beams, the multiple reading beams are not properly aligned, i.e. the reading beams are not perpendicular to the disc surface. The angular deviation can easily be derived from the distance between two beams and the difference between the corresponding two focus errors.

These and other aspects of the invention are apparent from and will be elucidated with reference to the embodiments described hereinafter.

### BRIEF DESCRIPTION OF THE DRAWINGS

In the drawings:

FIG. 1 schematically shows an embodiment of the device according to the invention,

FIGS. 2a, 2b and 2c show examples of beam splitting elements for use in the device according to the invention

FIGS. 3a and 3b respectively show an in-focus and an out-of-focus situation for light spots on segmented spot size detectors,

FIG. 4a schematically shows an in-focus situation for spot size detectors according to the invention and spot size detectors as previously used in single beam scanning devices,

FIG. 4b schematically shows an out-of-focus situation for spot size detectors according to the invention and spot size detectors as previously used in single beam scanning devices,

FIG. 5 schematically shows the light beam geometry, from which the dimensional requirements for the spot size detectors according to the invention are deduced,

FIG. 6 shows an S-curve obtained from spot size detectors as previously used in single beam scanning devices,

FIG. 7 shows an S-curve and a CA-signal obtained from spot size detectors according to the invention,

FIGS. 8a, 8b and 8c show exemplary arrangements of spot size detectors in a detector array for use in the device according to the invention,

FIGS. 9a and 9b show exemplary arrangements of glass plates for splitting at least one light beam, and

FIGS. 10a, 10b and 10c show exemplary arrangements for a detector array which is used in a scanning device, using glass plates for splitting the at least one light beam.

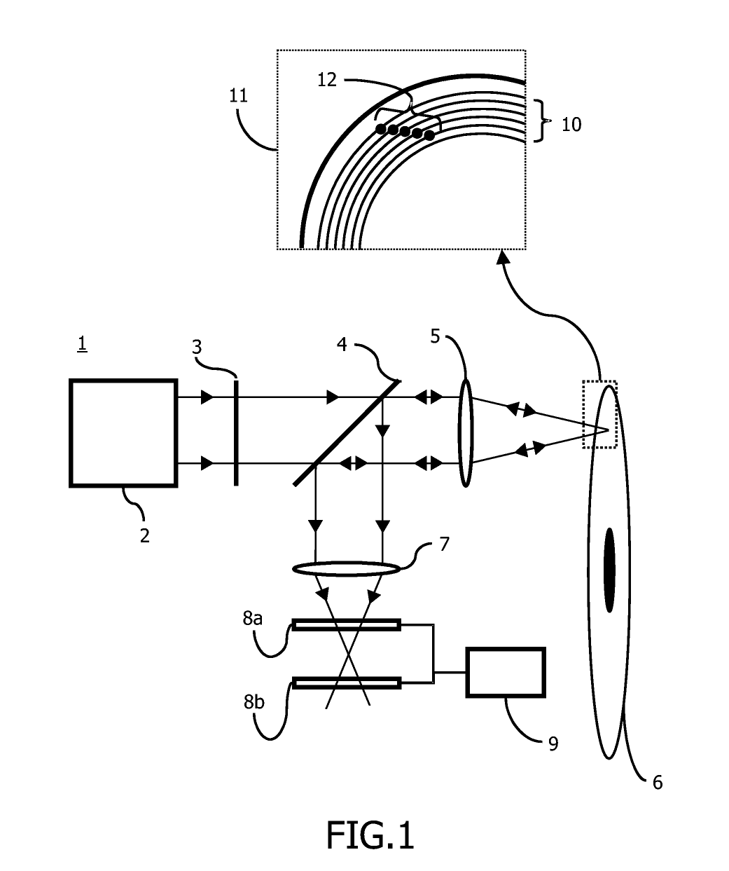

FIG. 1 schematically shows the device 1 according to the invention. The device comprises a light beam producing unit 1, which preferably produces a laser beam. The laser beam passes a diffractive element 3, for example a grating, where the beam is split into a plurality of parallel beams. The parallel beams pass a semi-permeable prism or mirror 4 and are focussed surface of an optical disc 6 by an objective lens 5 to project a plurality of light spots onto the tracks of the optical disc 6. In a detailed view 11 of part of the optical disc 6, a pattern of parallel tracks 10 is shown. The focussed light beams are reflected at the disc surface, pass the objective lens 5 and are reflected at the semi-permeable prism or mirror 4 towards a combined read-out and servo branch. Alternatively, using some extra light modulating elements, separate servo and read-out branches may be provided. In the read-out and servo branch the reflected beam is focussed by a lens 7 to project a plurality of detector light spots onto an array of signal detectors (not shown). The signal detectors convert the detector light spots into electric signals, representing the data on the tracks 10 of the optical disc 6.

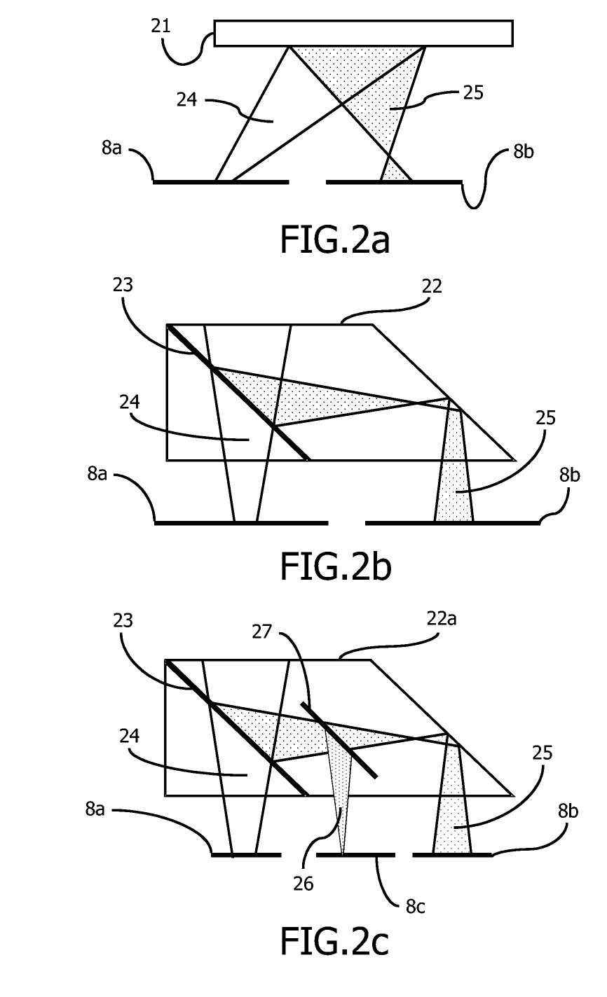

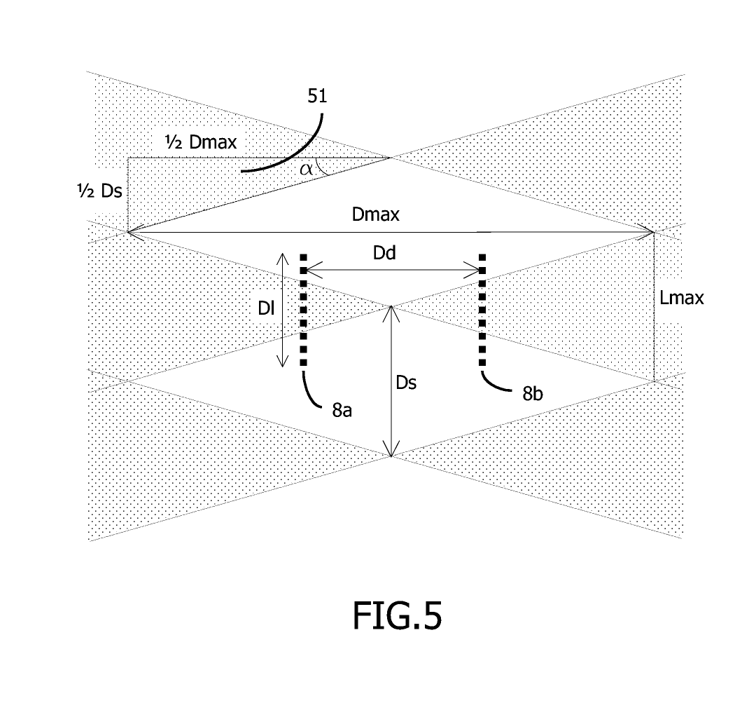

In the device 1 according to the invention at least one light beam is used for focus error detection. It is not necessary to measure a focus error for each track light spot. The focus error of one of the track light spots 12 is representative for the other track light spots 12. In general the central light beam or two light beams symmetric around the centre will be used, but in principle any light beam may be used. When using more than one beam for focus error detection, also an angle between the light beams and a normal to the disc surface may be detected. In the following we'll assume that only the central light beam is used for focus error detection. Unlike the other light beams, the central light beam is detected using segmented photo detectors. After passing the lens 7, the beams pass a beam splitter 21, 22 (FIG. 2). The beam splitter provides for the beam a first optical path 24 (FIG. 2) to a first segmented detector 8a and a second optical path 25 (FIG. 2) to a second segmented detector 8b. The lengths of the first optical path 24 and the second optical path 25 exhibit a difference Dd (FIG. 5), such that an intensity distribution of a detector light spot on the first segmented detector 8a is substantially equal to an intensity distribution of a detector light spot on the second segmented detector 8b when the central track light spot is correctly focussed and that the intensity distribution on the first segmented detector 8a differs from the intensity distribution on the second segmented detector 8b when the central light spot is not correctly focussed. A comparison unit 9 analyzes the electric signals from the segmented detectors 8a, 8b. From the electric signals the intensity distributions on the segmented detectors 8a, 8b are derived and compared. A focus error is calculated, using the differences between the intensity distributions on both segmented detectors 8a, 8b. In FIG. 1 a situation of correct focus is schematically shown. The length of the optical path to the second segmented detector 8b is greater than the length of the optical path to the first segmented detector 8a. The central light beam forms a pre-focal spot on the first segmented detector 8a and post-focal spot on the second segmented detector 8b. The other light beams form correctly focussed spots on their respective signal detectors (not shown). In general the pre-focal and the post-focal spot are provided by a beam splitting unit as described above and shown in FIG. 2. Alternatively detector 8a is a semi-transparent detector and both segmented detectors 8a and 8b are arranged as shown in FIG. 1.

FIGS. 2a, 2b and 2c show examples of beam splitting elements 21, 22, 22a for manipulating the beam in the device 1 according to the invention. The beam splitting elements 21, 22 provide, for the central light beam, the first optical path 24 to the first segmented detector 8a and the second optical path 25 to the second segmented detector. In the embodiment shown in FIG. 2a, the difference Dd is created by a holographic plate 21. In the embodiment shown in FIG. 2b, the difference Dd is created by a micro prism 22 comprising a semi-permeable mirror 23. In the embodiment shown in FIG. 2c the micro prism 22a further comprises a second semi-permeable mirror 27 for providing a third optical path 26 to a signal detector 8c. The length of the third optical path 26 is in the middle of the lengths of the first and second optical path, for providing a focal spot on the signal detector 8c. Other types of beam manipulating elements may be used for providing the difference Dd.

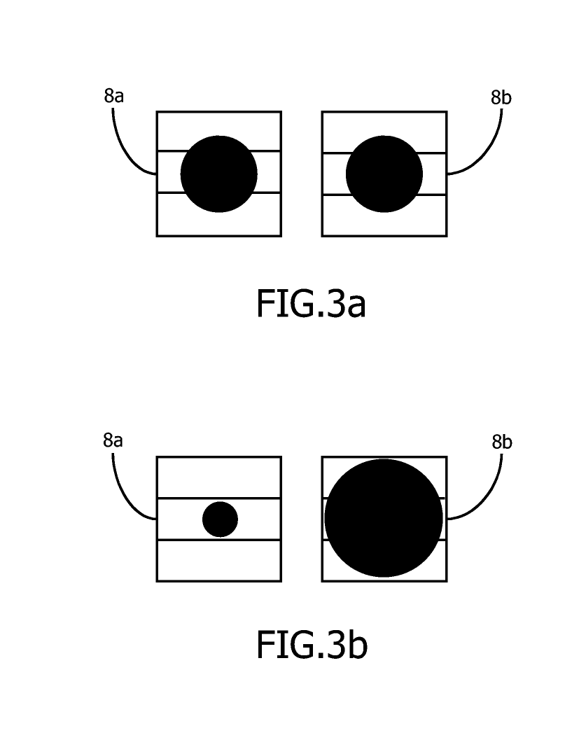

FIGS. 3a and 3b respectively show an in-focus and an out-of-focus situation for light spots on segmented spot size detectors. In the in-focus situation (FIG. 3a) the intensity distributions on both segmented detectors are equal. In the out-of-focus situation (FIG. 3b) one light spot is concentrated on the middle segment of the segmented detector 8a and the spot on the other segmented detector 8b is spread over its three segments. In alternative embodiments the segmented detectors may comprise more than three segments. An intensity distribution may also be measured, using a segmented detector with only two segments, but for reliable measurements a segmented detector with at least three segments is preferable. The comparing unit 9 compares the intensity distributions on both segmented detectors 8a and 8b and provides a focus error signal, indicating the amount and direction of the focus error.

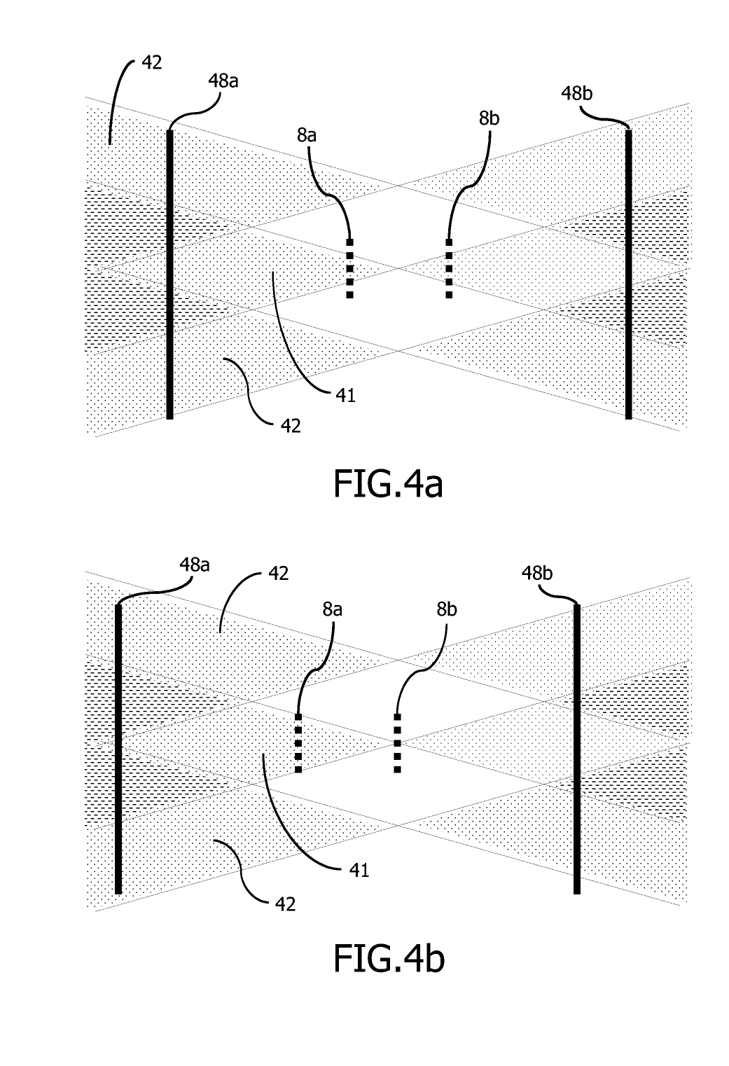

FIG. 4a schematically shows an in-focus situation for spot size detectors 8a, 8b according to the invention and spot size detectors 48a, 48b as previously used in single beam scanning devices. FIG. 3b schematically shows an out-of-focus situation for spot size detectors according to the invention. In single beam scanning devices the difference Dd between the lengths of the first and second optical path and the surface area of the segmented detectors 48a, 48b are preferably large, for enabling reliable focus error detection over a large range of focus errors. When the difference between the lengths of the optical paths is large, the focus point remains between the first and the second segmented detector 48a and 48b, even with large focus errors. As a result, even with large focus errors, a pre-focal spot is formed at one of the segmented detectors and a post-focal spot on the other segmented detector.

In multiple beams scanning devices, adjacent overlapping beams 42 negatively influence the quality of spot-size focus error detection. Close to the focus point of the second spot the beams 41, 42 are well separated, but out of focus the beams 41, 42 very quickly overlap. Even when no focus error occurs, adjacent beams 42 influence the intensity distribution on the segmented detectors 48a, 48b. Hence, up to now, spot size focus error detection has not been considered for multiple beams scanning devices. In the multiple beams scanning device 1 according to the invention the cross talk of overlapping beams 41, 42 is minimized by decreasing the difference Dd in optical path length. Additionally the size of the segmented detectors 8a and 8b used in the scanning device according to the invention should not exceed a certain limit. The intensity distribution of a spot formed on a too large detector 48a, 48b would be influenced by light from adjacent beams 42, even when no focus error occurs.

FIG. 5 schematically shows the light beam geometry, from which the dimensional requirements for the spot size detectors 8a and 8b according to the invention are deduced. The limits for the size of the detectors and the difference (Dd) between the lengths of the first and second optical path mainly depend on the distance (Ds) between two adjacent spots.

The maximum distance between two adjacent spots depends on the wavelength (λ) of the light and on the field of view and the numerical aperture (NA) of the lens 7 which focuses the light beams on the detectors. The field of view of a Blu Ray disc lens (NA=0.85, λ=405 nm) which is around 20 micrometer limits the maximum separation of the spots. For an 11-beams-system using a Blu Ray lens, the maximum separation is 20/11=1.8 micrometer. The minimal distance between two spots is limited by the interference of adjacent spots. If an adjacent spot is allowed to contribute less than 1% to the intensity of a focussed spot, the minimum separation of the spots is approximately 2.8*λ/NA=1.3 micrometer.

FIG. 5 shows a detail of three adjacent light beams. In focus the spots are separated by an amount of Ds. The difference Dd between the path lengths must not exceed a maximum distance Dmax in order to prevent overlapping beams falling onto the segmented detectors. Preferably, the difference Dd is kept substantially smaller than Dmax. In a preferred embodiment Dd is about half Dmax. Dmax can be calculated from the geometry, shown in FIG. 5. In FIG. 5 a right triangle 51 is shown, wherein an angle α, a side with length ½ Dmax and a side with length ½ Ds are indicated. The angle α is half of the angular aperture of the lens 7. The numerical aperture (NA) equals the sine of α. From this information Dmax is calculated to equal Ds/(2*tan (arc sin (NA))). For small values of NA Dmax approximately equals Ds/NA. The numerical aperture of the lens 7 for providing the detector light spots usually is around 0.1, which is small enough for justifying this approximation.

A maximum length (Lmax) of a light detecting area of the segmented detectors, measured in a direction towards adjacent spots, equals the distance (Ds) between two adjacent detector light spots. When using a larger detector, cross talk of adjacent overlapping beams would hamper the focus error detection.

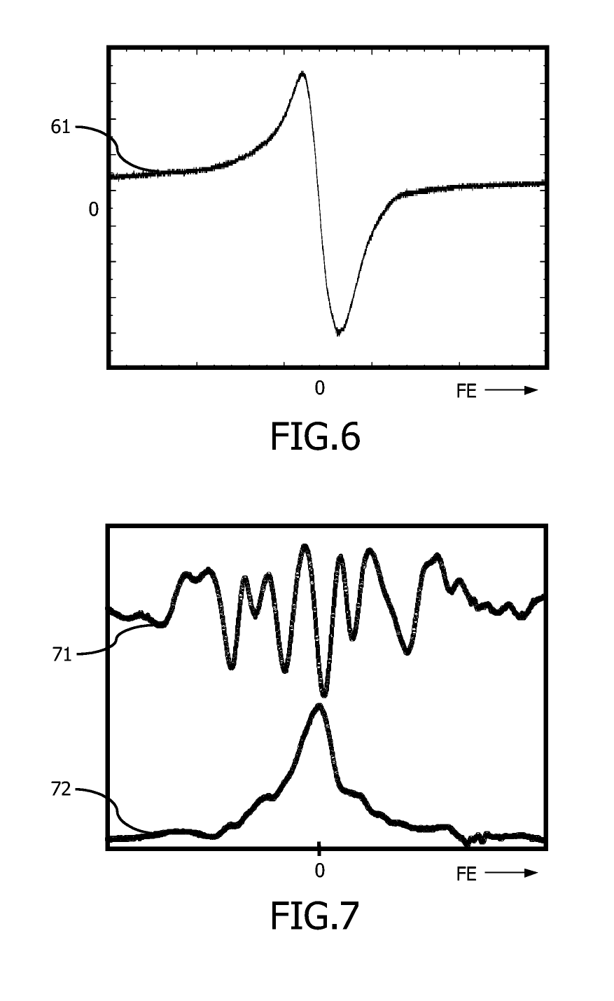

FIG. 6 shows an S-curve 61 obtained from spot size detectors as previously used in single beam scanning devices. The x-value of each point on the curve 61 represents a focus error. The y-value of each point on the curve represents an error signal value which is a function of the light intensities measured by the segments of both segmented detectors 8a, 8b. The error signal value may, for example, be calculated by inserting the light intensities on the different segments in the following formula:

$$\frac{( \begin{matrix}middle segment ( 1 ) + \\ outer segments ( 2 )\end{matrix} ) - ( \begin{matrix}middle segment ( 2 ) + \\ outer segments ( 1 )\end{matrix} )}{total intensity ( 1 ) + total intensity ( 2 )} ,$$

but other formulas may be used as well. Preferably, a function is used which results in a unique value for all focus errors within a large range of focus errors. Using the S-curve 61 and the signals from the segments of the segmented detectors shown in FIG. 6, the comparison unit 9 determines the size and the direction of the focus error.

FIG. 7 shows an S-curve 71 and a CA-signal 72 from a multiple beams scanning device according to the invention. For small focus errors, the curve 71 can be used by the comparison unit 9 like described above for a single beam scanning device. Due to interference of overlapping beams the error signal value is very unpredictable for larger focus errors. For enlarging the capture range of the focus detection system in multiple beams scanning devices according to the invention, additional measures are required. For example, a central amplitude (CA) signal 72 may be measured. The CA-signal represents the total sum of intensities on all segments of both segmented detectors 8a, 8b. The CA-signal is calculated by an addition unit, which simply adds the electric signals coming from the detector segments. The CA-signal peaks when the spot is approximately near-focus and is low when the spot is out-of focus. In a preferred embodiment of the scanning device according to the invention, first the CA-signal is used for approximately focussing the track light spots 12 on the optical disc and then the comparing means 9 determine the error signal value, using spot size detection.

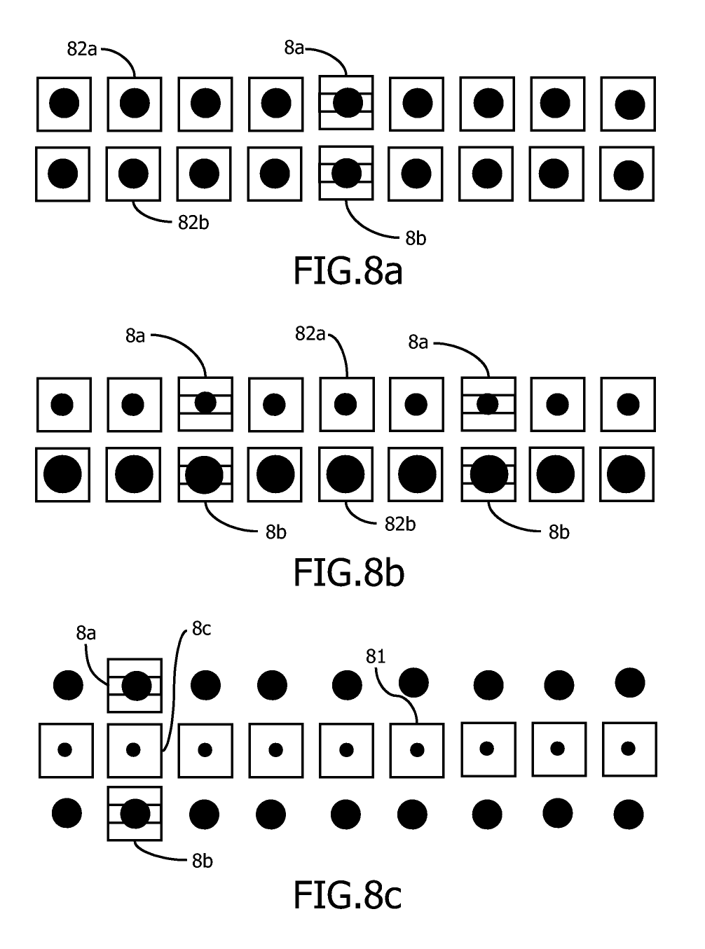

FIGS. 8a, 8b and 8c show exemplary arrangements of spot size detectors in a detector array for use in the device according to the invention. In FIG. 8a, a detector array is shown for signal detection in a 9-beams-system. In the scanning device using this detector array, the reflected light beams are split for enabling spot size focus error detection using the central light beam. Two separate paths with different lengths lead the central light beam to the segmented detectors 8a and 8b. The other beams are also split and form spots on the signal detectors 82a, 82b of eight signal detector pairs. However slightly out of focus, the signal detectors 82a, 82b are used for obtaining the data stored on the tracks 10 of the optical disc 6. It is to be noted that, when correctly focussed, the spots on both detectors 82a and 82b are identical and the use of only one detector of the pair of detectors will already enable data readout. Alternatively, a detector pair is replaced by one large detector for detecting both spots. The total intensity on the segmented detectors 8a, 8b is preferably also calculated and used for data read-out.

In FIG. 8b two beams, symmetric around the centre are used for focus error detection. When using more than one beam for focus error detection, also an angle between the light beams and a normal to the disc surface may be detected. When focus errors differ for different light beams, the multiple reading beams are not properly aligned, i.e. the reading beams are not perpendicular to the disc surface. The angular deviation can easily be derived from the distance between two beams and the difference between the corresponding two focus errors.

FIG. 8b shows an out-of-focus situation. The first segmented detector 8a is closer to the focal point of the laser beam than the second segmented detector 8b. For reliable data readout, the focus should be corrected and moved towards the second segmented detector 8b.

In FIG. 8c a single non-central beam is used for focus error detection. In the embodiment shown in FIG. 8c the beam splitter does not only provide a pre-focal and a post-focal spot, but also a focal spot. A beam splitter 22a as shown in FIG. 2c may be used for providing these three spots. The focal spot is focussed on a signal detector 8c, when the track light spots 12 are correctly focussed on the tracks 10 of the optical disc 6. The arrangement shown in FIG. 8c has the advantage that focussed detector light spots can be used for data read-out. It is however to be noted that splitting a beam into three beams results in beams with a lower intensity, than splitting a beam into two beams.

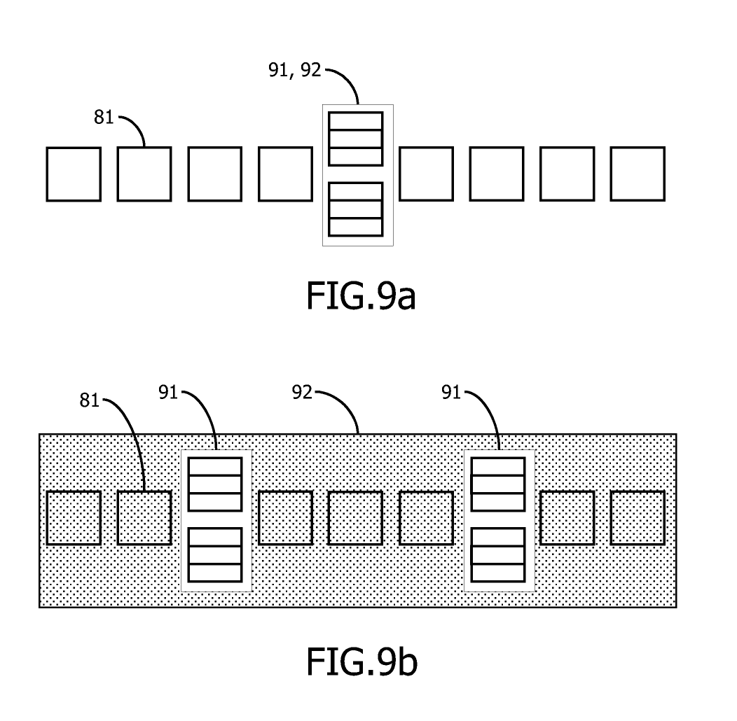

FIGS. 9a and 9b show exemplary arrangements of glass plates 92 for splitting at least one light beam. In FIG. 9a the glass plate 92 is a holographic part 91 for splitting the central light beam and providing the first optical path 24 and the second optical path 25. The holographic part 91 may, for example comprise, a micro version of one of the beam manipulating elements 21, 22, 22a as shown in FIG. 2. The other light beams are not split and directly fall on the signal detectors 81. In FIG. 9b a larger glass plate 92 is shown. The glass plate 92 comprises two holographic parts 91 for splitting two of the total of nine light beams. The remaining parts of the glass plate 92 are transmissive for letting the other beams directly fall on the signal detectors 81.

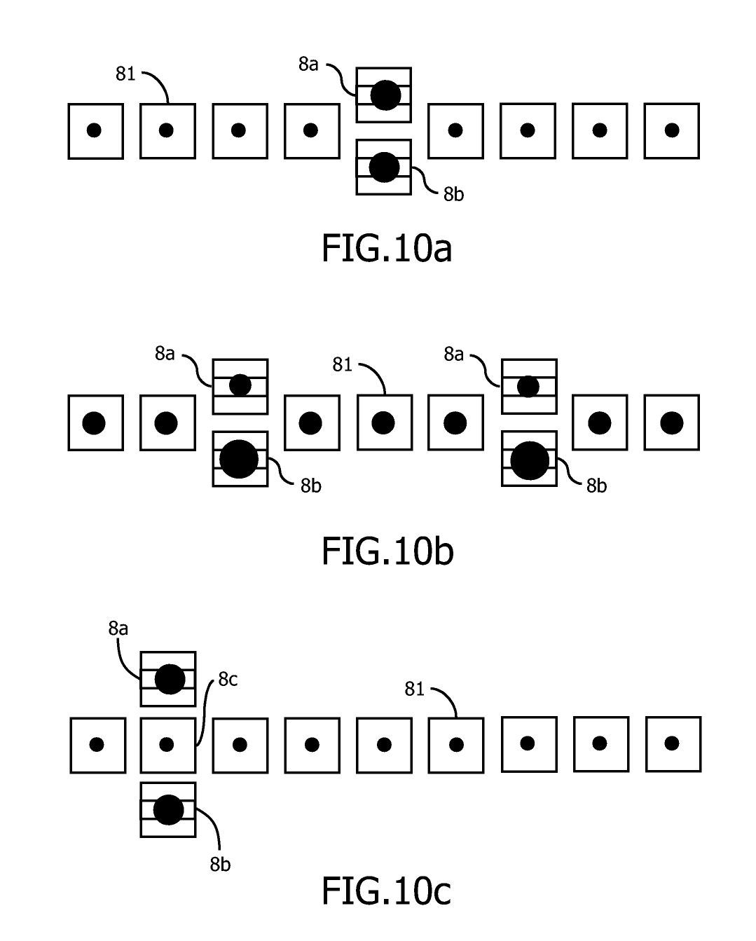

FIGS. 10a, 10b and 10c show exemplary arrangements for a detector array which is used in a scanning device, using glass plates for splitting the at least one light beam. The beam manipulating elements 21, 22, 22a shown in FIGS. 2a, 2b and 2c split all beams into two or three beams. It is a disadvantage of the beam manipulating elements 21, 22 shown in FIGS. 2a and 2b that the spots on the signal detectors 81 are not in focus. It is a disadvantage of the beam manipulating element 22a shown in FIG. 2c that the spots on the signal detectors 81 are significantly attenuated. When using the glass plates 92 shown in FIGS. 9a and 9b, only the beams which are used for spot size detection are split. Therefore it is possible to create correctly focussed spots with sufficient light intensity on the signal detectors 81 in FIGS. 10a, 10b and 10c.

It should be noted that the above-mentioned embodiments illustrate rather than limit the invention, and that those skilled in the art will be able to design many alternative embodiments without departing from the scope of the appended claims. In the claims, any reference signs placed between parentheses shall not be construed as limiting the claim. Use of the verb “comprise” and its conjugations does not exclude the presence of elements or steps other than those stated in a claim. The article “a” or “an” preceding an element does not exclude the presence of a plurality of such elements. The invention may be implemented by means of hardware comprising several distinct elements, and by means of a suitably programmed computer. In the device claim enumerating several means, several of these means may be embodied by one and the same item of hardware. The mere fact that certain measures are recited in mutually different dependent claims does not indicate that a combination of these measures cannot be used to advantage.

1. A device (1) for scanning an optical disc (6), the disc (6) comprising substantially parallel data tracks (10), the device (1) comprising
an optical unit for creating a plurality of track light spots (12) on the data tracks (10), the optical unit comprising a lens (7) for creating, from a plurality of light beams reflected at the data tracks (10), a plurality of detector light spots on a plurality of signal detectors, and
a focus error unit for providing a focus error signal, indicating an amount of defocus of at least one track light spot of the plurality of track light spots (12), the focus error unit comprising
a beam manipulating element (21, 22, 22a, 92) for providing for at least one of the reflected beams a first optical path (24) to a first segmented detector (8a) and a second optical path (25) to a second segmented detector (8b), the lengths of the first optical path (24) and the second optical path (25) exhibiting a difference (Dd), such that an intensity distribution of a first detector light spot on the first segmented detector (8a) is substantially equal to an intensity distribution of a second detector light spot on the second segmented detector (8b) when the at least one track light spot is correctly focussed and that the intensity distribution on the first segmented detector (8a) differs from the intensity distribution on the second segmented detector (8b) when the at least one track light spot is not correctly focussed, and
comparing means for comparing the intensity distribution on the first segmented detector (8a) to the intensity distribution on the second segmented detector (8b) for determining the focus error signal,
the difference (Dd) being substantially less than a quotient of a distance between two adjacent detector light spots (Ds) and a numerical aperture (NA) of the lens (7), and
a dimension (Dl) of a light detecting area of the segmented detectors in a direction of adjacent detector light spots being less than the distance (Ds) between two adjacent detector light spots.

2. A device (1) as claimed in claim 1, wherein the focus error unit comprises adding means for adding intensities detected by segments of the first segmented detector (8a) and the second segmented detector (8b) for providing an approximate focus error signal for.

3. A device (1) as claimed in claim 1, wherein the beam manipulating element (21, 22, 22a, 92) is arranged for providing for the at least one of the reflected beams a third optical path (26) to a signal detector (8c) additional to the first optical path (24) to the first segmented detector (8a) and the second optical path (25) to the second segmented detector (8b), the third optical path (26) having a length between the lengths of the first optical path (24) and the second optical path (25).

4. A device (1) as claimed in claim 1, wherein the plurality of signal detectors is arranged as a plurality of pairs of signal detectors (82a, 82b) and wherein the beam manipulating element (21, 22, 22a) is arranged for providing for each of the plurality of reflected beams a first optical path (24) to the first signal detector (82a) of a corresponding pair of the plurality of pairs and a second optical path (25) to the second signal detector (82b) of the corresponding pair.

5. A device (1) as claimed in claim 1, wherein the beam manipulating element is a glass plate (92) comprising a holographic part (91) for splitting the at least one of the reflected beams for providing the first optical path (24) and the second optical path (25).

6. A device (1) as claimed in claim 5, wherein the glass plate (92) further comprises a transmissive part for transmission of at least one of the reflected light beams which is not used for focus error detection.

7. A device (1) as claimed in claim 1, wherein the focus error unit is arranged for providing at least two focus error signals, for at least two track light spots (12) and for deriving an angular error signal from the at least two focus error signals.
